(19) United States
(12) Patent Application Publication
(10) Pub. No.: US 2011/0056878 A1
(43) Pub. Date: Mar. 10, 2011

(54) MEMBRANE FILTRATION SYSTEM

(76) Inventors: Takeshi Matsushiro, Yokohama-shi (JP); Nobuyuki Ashikaga, Kawasaki-shi (JP); Takashi Menju, Kawasaki-shi (JP); Futoshi Kurokawa, Tachikawa-shi (JP); Yoshie Akai, Yokohama-shi (JP); Koichi Matsui, Tokyo (JP); Hideaki Yamagata, Urayasu-shi (JP); Hideyuki Tsuji, Yokohama-shi (JP); Takanori Fukagawa, Yokohama-shi (JP); Takahiro Soma, Kawasaki-shi (JP)

(21) Appl. No.: 12/855,519

(22) Filed: Aug. 12, 2010

(30) Foreign Application Priority Data
Sep. 10, 2009 (JP) 2009-209524

(51) Int. Cl. C02F 1/44

(52) U.S. Cl. 210/257.2

(57) ABSTRACT

According to one embodiment, a membrane filtration system includes a raw water tank, a first tank, a second tank, a nanofiltration membrane module comprises a nanofiltration membrane, and removes the solute from the raw water with a solute removal rate of 1% to 30%, a first pump for supplying the raw water from the raw water tank to the module to cause the raw water to permeate through the membrane and send the water that has permeated through the membrane as a primary water to the first tank, a RO module comprises a RO membrane that further removes the solute from the primary water, and a second pump for supplying the primary water from the first tank to the RO module to cause the primary water to permeate through the membrane and send the water that has permeated through the membrane as a secondary water to the second tank.

### CROSS-REFERENCE TO RELATED APPLICATIONS

This application is based upon and claims the benefit of priority from Japanese Patent Application No. 2009-209524, filed Sep. 10, 2009; the entire contents of which are incorporated herein by reference.

### FIELD

Embodiments described herein relate generally to a membrane filtration system to be used for water treatment for brackish water, seawater, groundwater, landfill leachate, industrial wastewater, or the like containing a solute such as an ion and a salt.

### BACKGROUND

In the field of water treatment, filtration using a reverse osmosis membrane module has been employed for obtaining daily life water, industrial water, or agricultural water by filtering brackish water, seawater, groundwater, landfill leachate, industrial wastewater, or the like containing a solute such as an ion and a salt.

The reverse osmosis membrane is a membrane having a property of not allowing permeation of an impurity (solute) other than water, such as an ion and a salt. A pressure equal to or more than an osmotic pressure according to a concentration of the solute is applied on the reverse osmosis membrane from a high pressure pump to separate the solute from water. In a membrane filtration system using the above-described reverse osmosis membrane, when the solute concentration is high as in seawater, the pressure required for the filtration must be increased to entail an increase in power cost for driving the high pressure pump.

In order to solve the above-described problem, JP-A 2002-282855(KOKAI), JP-A 2003-200161(KOKAI), and JP-A 2008-100219(KOKAI) propose a means of obtaining desalinated water or clear water by: providing a nanofiltration membrane module in a stage anterior to the above-described reverse osmosis membrane module using the reverse osmosis membrane; firstly supplying brackish water, seawater, groundwater, landfill leachate, industrial wastewater, or the like containing solute such as an ion and a salt to the nanofiltration membrane module for membrane separation into permeated water and concentrated water; and supplying the permeated water to the reverse osmosis membrane module.

However, since the nanofiltration membrane is fouled in a short time when brackish water, seawater, groundwater, landfill leachate, industrial wastewater, or the like containing solute such as an ion and a salt is supplied to the nanofiltration membrane module in the conventional membrane filtration systems, it is necessary to frequently perform membrane cleaning in order to solve the fouling. Therefore, since it is necessary to stop the operation of filtration treatment from time to time, it is impossible to continue the operation for a long time to deteriorate treatment efficiency, and a total running cost is raised due to an increase in power cost for driving the high pressure pump.

An object of the embodiments is to provide a membrane filtration system capable of reducing a total running cost by reducing a power cost for a high pressure pump used for supplying raw water to a reverse osmosis membrane module by way of suppression of fouling of a filtration membrane and removal of a part of solute such as an ion and a salt.

In general, according to one embodiment, the solute is eliminated by using the nanofiltration membrane in such a manner that the solute removal rate becomes 1% or more, and 30% or less in the nanofiltration membrane module. In the case where the solute removal rate in the single nanofiltration membrane exceeds 30%, a load on the pump is increased, and the filtration membrane is easily fouled to raise necessity of frequent filtration membrane cleaning in a short cycle, thereby largely deteriorating treatment efficiency. By the way, in order to pass water through the nanofiltration membrane module and the reverse osmosis membrane module, it is necessary to apply an operation pressure that is equal to or more than an osmotic pressure according to a solute concentration at a membrane module entrance. The solute removal rate and a recovery rate are decided in such a manner as to match the osmotic pressure to the operation pressure of the nanofiltration membrane module. Since a solute concentration at a concentrated water side is increased when a solute concentration at a treated water side is reduced, the operation pressure of the nanofiltration membrane module is ultimately increased when the solute removal rate is increased. In order to avoid such increase in operation pressure, the operation pressure of the nanofiltration membrane module is reduced by suppressing the solute removal rate in the nanofiltration membrane module to a lower value of 30% or less, and, at the same time, a concentration of solute to be supplied to the posterior reverse osmosis membrane module is reduced, thereby distributing the load incurred by the solute removal and reducing a total power required for the solute removal.

Meanwhile, when the solute removal rate in the nanofiltration membrane module is less than 1%, effective efficiency of the treatment in the nanofiltration membrane module becomes excessively low to make it difficult to attain the object of mitigating the load on the posterior reverse osmosis membrane module. In this case, the cost is increased when the number of nanofiltration membrane modules is increased for the purpose of mitigating the load on the reverse osmosis membrane module.

In the present embodiment, the solute removal rate in the nanofiltration membrane may more preferably be set to 1% or more, and 10% or less. When the solute removal rate is 10% or less, the load on the pump is further mitigated to reduce the power. In contrast, when the solute removal rate exceeds 10%, it is difficult to restore the clogged nanofiltration membrane to its original state by the cleaning treatment, thereby entailing in some cases rapid deterioration of membrane quality.

In the present embodiment, it is preferable to dispose a plurality of nanofiltration membrane modules at a stage anterior to the reverse osmosis membrane module (FIGS. 2, 3A, 3B, 3C, 3D, 4, 5, 6, and 8). When the solute concentration is gradually reduced by removing the solute gradually from the raw water by using the multi-stage nanofiltration membrane modules, an advantage of suppression of occurrence of fouling of the filtration membrane by mitigating a load on the nanofiltration membrane module at each of the stages is attained. In this case, too, a solute removal rate in the nanofiltration membrane module at each of the stages may preferably be set to 1% or more, and 30% or less, more preferably 1% or more, and 10% or less. In the case of subjecting a large amount of raw water (seawater) containing a high concentration of solute such as an ion and a salt in a seawater desalination plant or the like, it is desirable to keep the nanofiltration membrane modules to a maintenance-free state within an acceptable range and to an utmost extent, while it is required to prevent fouling of the filtration membranes to an utmost extent. Therefore, an enormous number of nanofiltration membrane modules of the order of several thousands to several tens of thousands are provided in the seawater desalination plant or the like to perform operation by using a parallel treatment and a rotation treatment in combination, thereby mitigating a load on each of the filtration membranes.

In the present embodiment, it is preferable to include a cleaning unit that is used at a predetermined frequency when cleaning the reverse osmosis membrane and nanofiltration membrane and for cleaning in such a manner by supplying hot water having a temperature higher than an ordinary temperature to each of the reverse osmosis membrane and the nanofiltration membrane (FIG. 4). It is possible to prevent deterioration of filtration treatment efficiency, to achieve life extension of the filtration membrane, and to mitigate the pump load by cleaning each of the reverse osmosis membrane and the nanofiltration membrane with the hot water at an appropriate frequency. Further, it is possible to largely mitigate an environmental load by using the hot water cleaning unit that does not use any chemical drugs.

In the present embodiment, a sand filtration device comprising a sand charged layer may further be disposed at a stage anterior to the nanofiltration membrane module (FIG. 5). Further, a microfiltration membrane module or an ultrafiltration membrane module may further be disposed at a stage anterior to the nanofiltration membrane module (FIG. 6). Further, the sand filtration device and the microfiltration membrane module or the sand filtration device and the ultrafiltration membrane module may be disposed at a stage anterior to the nanofiltration membrane module (FIG. 7 and FIG. 8).

In the present embodiment, it is preferable to further include a cleaning unit that is used at a predetermined frequency when cleaning each of the reverse osmosis membrane and the nanofiltration membrane, the sand charged layer and the microfiltration membrane, or the sand charged layer and the ultrafiltration membrane and for cleaning in such a manner by supplying hot water having a temperature higher than an ordinary temperature to each of the reverse osmosis membrane and the nanofiltration membrane, the sand charged layer and the microfiltration membrane, or the sand charged layer and the ultrafiltration membrane (FIGS. 1, 2, 4, 5, 6, 7 and 8). In the case of using the plurality of different filtration units in combination as described above, the cleaning of each of the units with the hot water is effective for realizing improvement in treatment efficiency, prevention of fouling of filtration membrane, and mitigation of pump load.

Hereinafter, terms used in the present specification will be defined.

The term “removal rate in nanofiltration membrane module” means an index number that indicates, in percentage, a ratio of a reduction in solute concentration C2 (mg/l) at an exit side to a solute concentration C1 (mg/l) at an entrance side in the nanofiltration membrane module. The solute means a substance that is dissolved into, for example, brackish water, seawater, groundwater, landfill leachate, industrial wastewater, or the like. The solute removal rate R (%) in the nanofiltration membrane module is given by the following expression (1):

R={1−(C2/C1)}×100 (1)

The term “recovery rate in nanofiltration membrane module” means an index number that indicates, in percentage, a ratio of a flow rate F2 at an exit side valve to a flow rate F1 at an entrance side valve in the nanofiltration membrane module. The solute recovery rate K (%) in the nanofiltration membrane module is given by the following expression (2):

K=(F2/F1)×100 (2)

The term “physical cleaning” means a cleaning method of supplying pressurized water to the filtration membrane for physically detaching a deposit from a surface of the membrane by a permeation pressure (penetration force and collision force) of the pressurized water.

The term “hot water cleaning” means a cleaning method of allowing hot water of a temperature of 40° C. or more (temperature higher than an ordinary temperature) to permeate through the filtration membrane to remove a deposit from a surface of the filtration membrane. Since no chemical drug is used in the hot water cleaning, it is possible to attain advantages of a simple discharge treatment after the cleaning and a small environmental load. When a functional hollow fiber treated with a temperature responsive polymer is used for the membrane surface, the effect of hot water cleaning is further enhanced because a diameter of each of pores is increased due to helical shrinkage of a chain of the polymer caused by a contact with the hot water.

The term “sand filtration” means a filtration method for removing a solid content in raw water by passing the raw water to a sand charged layer that is charged with sand. In the present embodiment, the sand filtration is utilized as a pre-treatment for removing a solid content having a relatively large size for the purpose of mitigating a load on the nanofiltration membrane at a stage anterior to the nanofiltration membrane.

### BRIEF DESCRIPTION OF THE DRAWINGS

FIG. 1 is a block diagram showing a membrane filtration system according to a first embodiment;

FIG. 2 is a block diagram showing a membrane filtration system according to a second embodiment;

FIG. 3A is a block diagram schematically showing the membrane filtration system of the embodiment;

FIG. 3B is a diagram illustrating a function and an effect of the membrane filtration system of the embodiment;

FIG. 3C is a diagram illustrating a function and an effect of the membrane filtration system of the embodiment;

FIG. 3D is a diagram illustrating a function and an effect of the membrane filtration system of the embodiment;

FIG. 4 is a block diagram showing a membrane filtration system according to a third embodiment;

FIG. 5 is a block diagram showing a membrane filtration system according to a fourth embodiment;

FIG. 6 is a block diagram showing a membrane filtration system according to a fifth embodiment;

FIG. 7 is a block diagram showing a membrane filtration system according to a sixth embodiment; and

FIG. 8 is a block diagram showing a membrane filtration system according to a seventh embodiment.

### DETAILED DESCRIPTION

Certain embodiments will be described below with reference to the accompanying drawings.

### First Embodiment

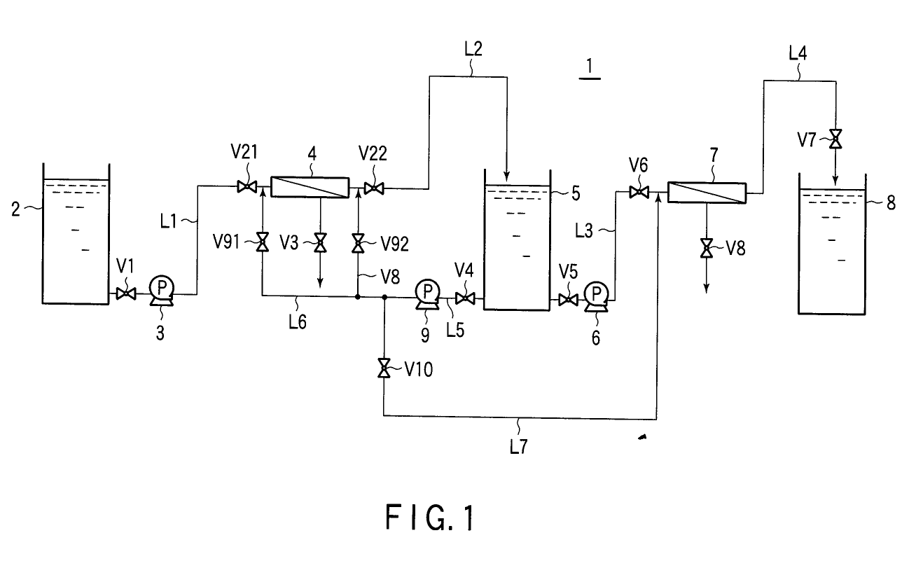

A membrane filtration system according to a first embodiment will be described with reference to FIG. 1.

The membrane filtration system 1 of the present embodiment comprises a raw water tank 2, a first supply pump 3, a nanofiltration membrane module 4, a first treated water tank 5, a second supply pump (high pressure pump) 6, a reverse osmosis membrane module 7, and a second treated water tank 8 in this order from an upstream side. The units 2 to 8 are serially connected by water piping lines L1 to L4 serving as main process lines, so that water to be treated is intermittently or continuously sent toward the second treatment tank 8 at a downstream side from the raw water tank 2 at the upstream side in a steady operation. Open/close valves V1, V21, V22, V5, V6, and V7 are disposed at appropriate positions of the lines L1 to L4, and a controller (not shown) controls open/close of the valves at desired timings in accordance with predetermined process conditions.

The raw water tank 2 is a reservoir tank for: supplying brackish water, seawater, groundwater, landfill leachate, industrial wastewater, or the like containing solute such as an ion and a salt from a raw water supply source (not shown); temporarily retaining the raw water for a desired period of time; and causing a solid content to precipitate.

The nanofiltration membrane module 4 is disposed between the raw water tank 2 and the first treated water tank 5 and incorporates a nanofiltration membrane for removing the solute contained in the raw water. The nanofiltration membrane is a functional filtration membrane comprising pores having an average pore diameter that is larger than that of a reverse osmosis membrane. As a mode of usage of the nanofiltration membrane, a nanofiltration membrane which is a bundle of hollow fiber membranes is inserted into a filtration membrane module container, for example. The nanofiltration membrane module 4 has a function of removing a part of the solute contained in a large amount in the raw water and has a role of mitigating a load on the reverse osmosis membrane module 7 disposed at a posterior stage.

The first supply pump 3 is attached to the raw water supply line L1 that connects the raw water tank 2 to the nanofiltration membrane module 4. The first supply pump 3 applies a desired operation pressure to the nanofiltration membrane by supplying the raw water to the nanofiltration membrane module 4 at a predetermined pump supply pressure. The raw water permeates through the nanofiltration membrane due to the supply pressure of the pump 3, so that a part of the solute is removed to generate primary treated water.

The first treated water tank 5 is connected to the exit side of the nanofiltration membrane module 4 by the line L2 comprising the valve V 22 and houses the primary treated water obtained by the removal of a part of solute by the nanofiltration membrane.

The reverse osmosis membrane module 7 is disposed between the first treated water tank 5 and the second treated water tank 8 and incorporates a reverse osmosis membrane for removing the solute contained in the primary treated water. The reverse osmosis membrane is a functional filtration membrane that comprising pores having an average pore diameter of less than 2 nm for allowing a water molecule to pass therethrough and not allowing impurities (solute) other than the water molecule to pass therethrough. The reverse osmosis membrane separates the solute from water when a pressure equal to or more than an osmotic pressure according to a concentration of the solute (impurity) is applied thereto. The reverse osmosis membrane module 7 is provided with a function of almost perfectly removing the solute contained in the primary treated water and has a role of producing desalinated water.

The second treated water tank 8 is connected to the exit side of the nanofiltration membrane module 7 by the line L4 comprising the valve V7 and houses secondary treated water (desalinated water) obtained by the removal of almost entire solute by the reverse osmosis membrane.

The second supply pump 6 is attached to the primary treated water supply line L3 connecting the first treated water tank 5 to the reverse osmosis membrane module 7. The second supply pump 6 applies a desired operation pressure to the reverse osmosis membrane by supplying the primary treated water to the reverse osmosis membrane module 7 at a predetermined pump supply pressure. As the second supply pump 6, a high pressure pump such as a reciprocating pump and a multistage swirl pump may be used. The primary treated water permeates through the reverse osmosis membrane due to the supply pressure of the pump 6, so that the solute is almost perfectly removed to generate the secondary treated water.

Further, the membrane filtration system 1 comprises a cleaning pump 9 that is disposed between the nanofiltration membrane module 4 and the first treated water tank 5. Of the cleaning pump 9, an inlet side is connected to the first treated water tank 5 via a line L5 comprising a valve V4, and an outlet side is connected to branch lines L6, L7, and L8. The first branch line L6 is a cleaning line for the nanofiltration membrane module 4, which is connected to the entrance side of the nanofiltration membrane module 4 and comprises an open/close valve V91. The second branch line L8 is a reverse cleaning line for the nanofiltration membrane module 4, which is connected to the exit side of the nanofiltration membrane module 4 and comprises an open/close valve V92. The third branch line L7 is a cleaning line for the reverse osmosis module 7, which is connected to the entrance side of the reverse osmosis module 7 and comprises an open/close valve V10.

Hereinafter, a function of the present embodiment will be described.

For the filtration operation, the valves V1, V3, V8, V21, V22, V5, V6, and V7 are opened, and the valves V3, V8, V91, V92, and V10 are closed. The raw water is supplied from the raw water tank 2 to the nanofiltration membrane module 4 via the line L1 by the driving of the pump 3, and treated water obtained by the treatment by the nanofiltration membrane module 4 is temporarily stored in the first treated water tank 5 and then supplied to the reverse osmosis membrane module 7 by the high pressure pump 6. A recovery rate K of the nanofiltration membrane module 4 is defined by a flow rate at the valve V22 with respect to a flow rate at the valve V21 as shown in the expression (2). Further, a removal rate R of the nanofiltration membrane module 4 is given by a solute concentration C2 at the exit of the membrane module with respect to a solute concentration C1 at the entrance of the membrane module shown in the expression (1).

There are two types of physical cleanings for the nanofiltration membrane module 4, namely, the cleaning pump 9 is activated when the valve V91 is opened in a state where the valve V21 and V22 are closed or when the valve V92 is opened followed by opening the valve V4 in a state where the valves V21 and V22 are closed. Cleaning water is discharged from the nanofiltration membrane module 4 by opening the drain valve 3. In the former cleaning treatment process, the cleaning water is caused to flow the treated water tank 5, L5, V4, the pump 9, L6, V91, the module 4, and V3 in this order to clean the filtration membrane in the module 4. In the latter reverse cleaning treatment process, the cleaning water is caused to flow the treated water tank 5, L5, V4, the pump 9, L8, V92, the module 4, and V3 in this order to reverse-clean the filtration membrane in the module 4.

In physical cleaning of the reverse osmosis membrane module 7, the cleaning water is sent to the reverse osmosis membrane module 7 via the line L7 by driving the cleaning pump 9 in a state where the valves V6 and V7 are closed and the valve 10 is opened. The cleaning water used for the cleaning is discharged from a drain line at a bottom of the module by opening the valve V8. In the cleaning treatment of the reverse osmosis membrane, the cleaning water is caused to flow the treated water tank 5, L5, V4, the pump 9, L7, V10, the module 7, and V8 in this order to clean the reverse osmosis membrane.

According to the present embodiment, since the nanofiltration membrane module formed of the nanofiltration membrane for removing a part of the solute is disposed at the stage anterior to the reverse osmosis membrane module, fouling of the nanofiltration membrane module is reduced, and a part of the solute such as an ion and a salt is removed, thereby making it possible to reduce a power cost for the high pressure pump for supplying the raw water to the reverse osmosis membrane module, resulting in a reduction of a total running cost.

### Second Embodiment

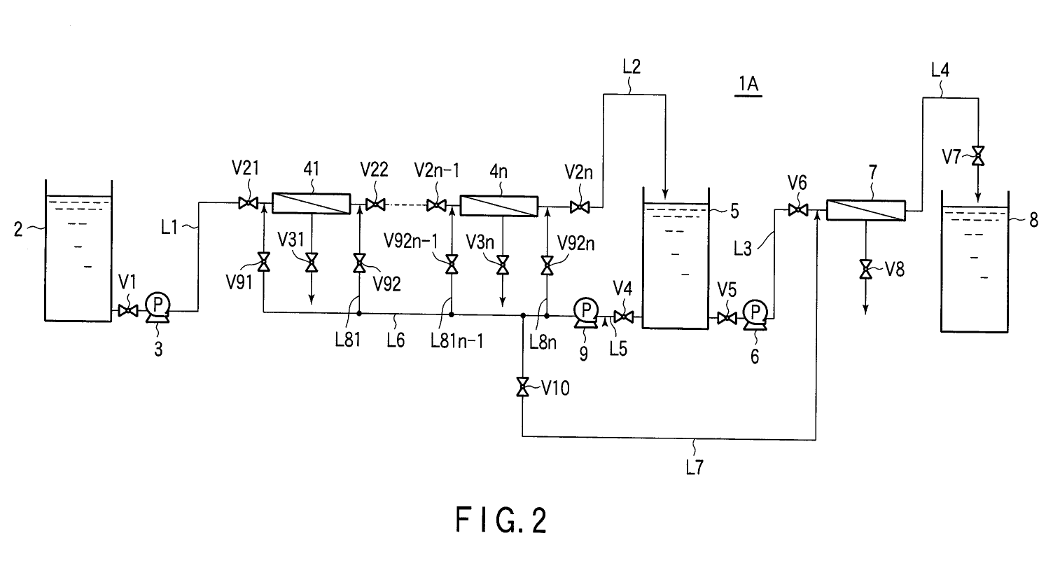

Hereinafter, a membrane filtration system of a second embodiment will be described with reference to FIG. 2. Description for a part of the present embodiment that is in common to the foregoing embodiment will be omitted.

A membrane filtration system lA of the present embodiment comprises a plurality of nanofiltration membrane modules 41 to 4n that are disposed between a raw water tank 2 and a first treated water tank 5. The plurality of nanofiltration membrane modules 41 to 4n are serially connected along a line L1 to L2. Valves V21, V22, . . . V2n are disposed at entrance sides and exit sides of the nanofiltration membrane modules 41 to 4n. More specifically: a communication is provided between the entrance side of the first stage module 41 and an outlet side of a first supply pump 3 via the valve V21; a communication is provided between the entrance side of the second stage module 42 and the exit side of the first stage module 41 via the valve V22; a communication is provided between the entrance side of the n-stage module 4n and the exit side of the n−1 stage module 4n−1 via the valve V2n−1; and a communication is provided between the exit side of the n-stage module 4n and the first treated water tank 5 via the valve V2n.

Further, to the lines connecting the entrance sides and the exit sides of the nanofiltration membrane modules 41 to 4n, cleaning/reverse cleaning lines L81 to L8n that are branched from a cleaning line L6 comprising a cleaning pump 9 are connected. Valves V91 and V92 to V92n are attached to the cleaning/reverse cleaning lines L81 to L8n. Further, bottom parts of the nanofiltration membrane modules 41 to 4n are connected to a drain line comprising the valves V31 to V3n.

Hereinafter, a function of the present embodiment will be described.

For the filtration, the valves V1, V31 to 3n, V8, V21, V22, V5, V6, and V7 are opened, and the valves V31 to V3n, V8, V91 to V9n, and V10 are closed. The raw water is supplied from the supply pump 3 to the nanofiltration membrane modules 41 to 4n, and treated water from the nanofiltration membrane module 41 to 4n is supplied to the reverse osmosis membrane module 7 by the high pressure pump (second supply pump) 6. A recovery rate K of the nanofiltration membrane modules 41 to 4n is defined by a flow rate at the valve V22 with respect to a flow rate at the valve V21 as shown in the expression (2). Further, a removal rate R of the nanofiltration membrane modules is given by a solute concentration at the exit of the membrane module with respect to a solute concentration at the entrance of the membrane module as shown in the expression (1). Here, the solute removal rate in the nanofiltration membrane module may preferably be within a range of 1% to 30% in order to reduce fouling of the nanofiltration membrane. When the solute removal rate exceeds 30%, the nanofiltration membrane is clogged in a short time to disturb continuous operation.

In order to cause water to pass through the nanofiltration membrane modules 41 to 4n and the reverse osmosis membrane module 7, it is necessary to apply an operation pressure equal to or more than an osmotic pressure according to the solute concentration at the entrance side of the membrane module. The removal rate R and the recovery rate K are decided in such a manner as to match the osmotic pressure to the operation pressure of the nanofiltration membrane modules 41 to 4n. Since a solute concentration at a concentrated water side is increased when a solute concentration at a treated water side is reduced, the operation pressure of the nanofiltration membrane module is ultimately increased when the solute removal rate R is increased. In order to avoid such increase in operation pressure, the operation pressure of the nanofiltration membrane modules 41 to 4n is reduced by suppressing the solute removal rate in the nanofiltration membrane module to a lower value of 1% to 30%, i.e. by roughly removing the solute, and, at the same time, a concentration of solute to be supplied to the posterior reverse osmosis membrane module 7 is reduced, thereby distributing the load incurred by the solute removal and reducing a total power required for the solute removal.

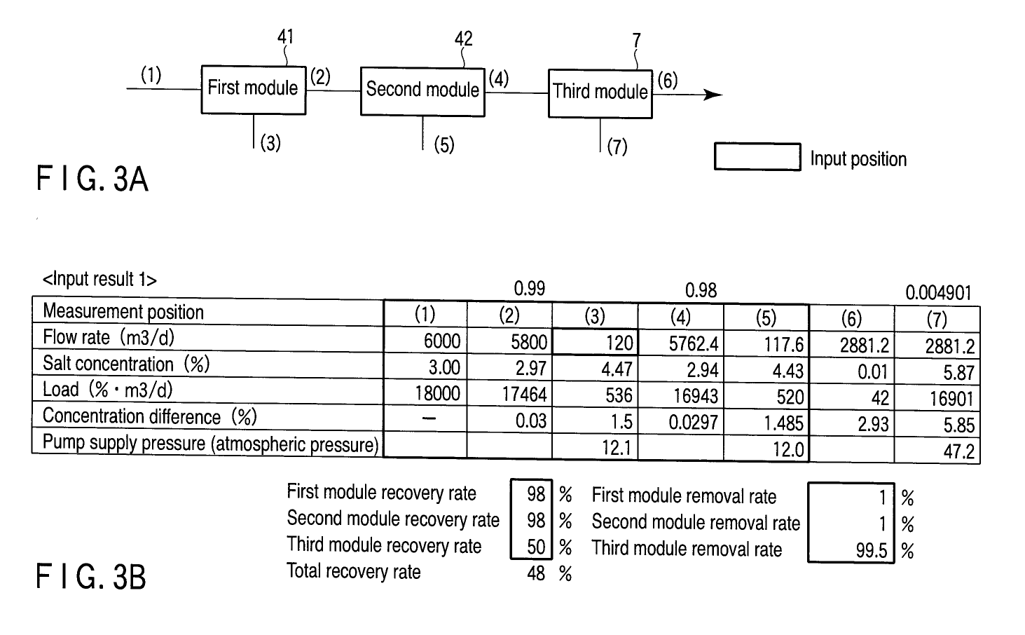

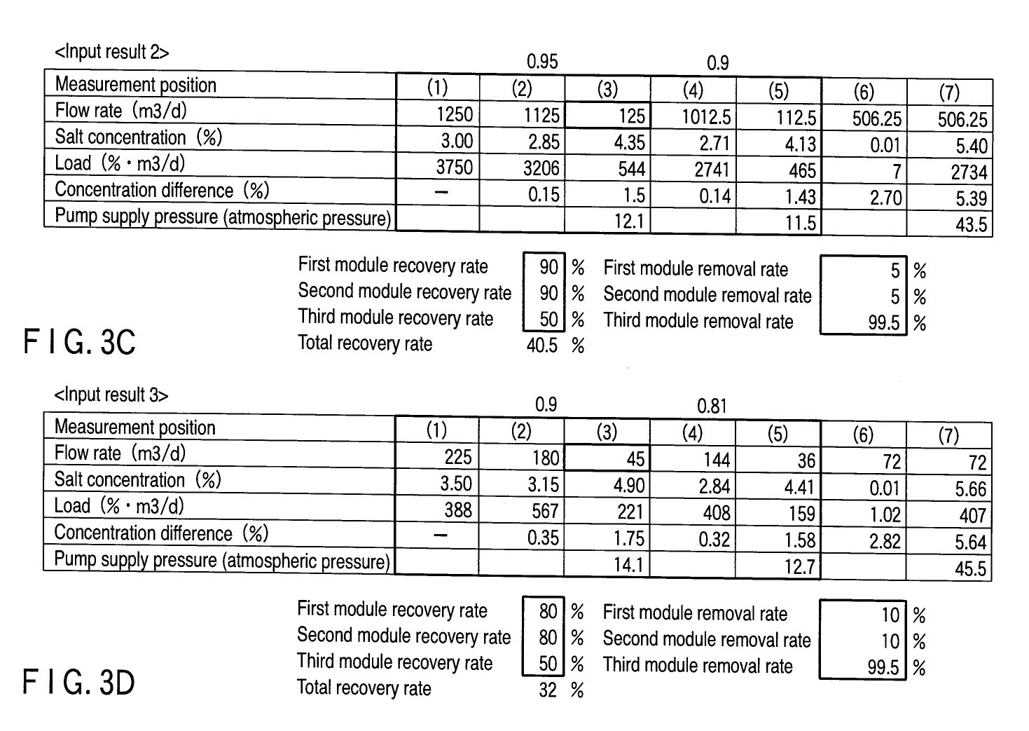

Hereinafter, as to a model of using the plurality of nanofiltration membrane modules and the reverse osmosis membrane module in combination as a virtual mode that is in conformity with the above-described embodiment, an input result 1, an input result 2, and an input result 3 obtained by computer simulations under three different process conditions will be described with reference to FIG. 3A, FIG. 3B, FIG. 3C, and FIG. 3D.

Shown in FIG. 3A is an example of a model in which the solute removal rate R by the nanofiltration membrane modules is set within a range of 1% to 10%; a target value of the pump supply pressure to the first nanofiltration membrane module 41 is set to about 15 atmospheric pressure (1.52 MPa); and one reverse osmosis membrane module 7 is connected as a stage posterior to two nanofiltration membrane modules 41 and 42. Measurement positions (1) to (7) of the input results 1 to 3 correspond to the following positions shown in FIG. 3A.

Measurement position (1): entrance port of first nanofiltration membrane module 41.

Measurement position (2): exit port of first nanofiltration membrane module 41.

Measurement position (3): concentrated water exit side of first nanofiltration membrane module 41.

Measurement position (4): exit port of second nanofiltration membrane module 42.

Measurement position (5): concentrated water exit side of second nanofiltration membrane module 42.

Measurement position (6): exit port of third reverse osmosis membrane module 7.

Measurement position (7): concentrated water exit side of third reverse osmosis membrane module 7.

As shown in FIG. 3B, in the input result 1: a salt concentration of the raw water at the measurement position (1) was 3.00%; a salt concentration of the primary treated water from the first module at the measurement position (2) was 2.97%; a salt concentration of the primary treated water from the second module at the measurement position (4) was 2.94%; and a salt concentration of the secondary treated water from the third module at the measurement position (6) was 0.01%. As to a pump supply pressure corresponding to the osmotic pressure of each of the filtration membranes: a pump supply pressure of 12.1 atmospheric pressure was achieved at the measurement position (3); a pump supply pressure of 12.0 atmospheric pressure was achieved at the measurement position (5); and a pump supply pressure of 47.2 atmospheric pressure was achieved at the measurement position (7).

As shown in FIG. 3C, in the input result 2: a salt concentration of the raw water at the measurement position (1) was 3.00%; a salt concentration of the primary treated water from the first module at the measurement position (2) was 2.85%; a salt concentration of the primary treated water from the second module at the measurement position (4) was 2.71%; and a salt concentration of the secondary treated water from the third module at the measurement position (6) was 0.01%. As to a pump supply pressure corresponding to the osmotic pressure of each of the filtration membranes: a pump supply pressure of 12.1 atmospheric pressure was achieved at the measurement position (3); a pump supply pressure of 11.5 atmospheric pressure was achieved at the measurement position (5); and a pump supply pressure of 43.5 atmospheric pressure was achieved at the measurement position (7).

As shown in FIG. 3D, in the input result 3: a salt concentration of the raw water at the measurement position (1) was 3.50%; a salt concentration of the primary treated water from the first module at the measurement position (2) was 3.15%; a salt concentration of the primary treated water from the second module at the measurement position (4) was 2.84%; and a salt concentration of the secondary treated water from the third module at the measurement position (6) was 0.01%. As to a pump supply pressure corresponding to the osmotic pressure of each of the filtration membranes: a pump supply pressure of 14.1 atmospheric pressure was achieved at the measurement position (3); a pump supply pressure of 12.7 atmospheric pressure was achieved at the measurement position (5); and a pump supply pressure of 45.5 atmospheric pressure was achieved at the measurement position (7).

There are two types of physical cleanings for the nanofiltration membrane modules 41 and 42, namely, the cleaning pump 9 is activated in a state where the valves V21 to V2n are closed and the valves V91 to V92n−1 are opened or in a state where the valves V21 and V2n are closed and the valves V92 to V92n are opened followed by opening of the valve V4. Cleaning water is discharged from the modules via the drain valves V31 to V3n. In physical cleaning of the reverse osmosis membrane module 7, the cleaning pump 9 is activated in a state where the valves V6 and V7 are closed and the valve V10 is opened. Cleaning water is discharged from the module 7 via the drain valve V8. More specifically, in the cleaning treatment of the nanofiltration membrane, the cleaning water is caused to flow the treated water tank 5, L5, V4, the pump 9, L6, L81 to L8n−1, V91, V92 to V92n−1, the modules 4 to 4n, and V31 to V3n in this order to clean the filtration membrane. In the reverse cleaning treatment of the nanofiltration membrane, the cleaning water is caused to flow the treated water tank 5, L5, V4, the pump 9, L81 to L8n−1, V92 to V92n−1, the modules 4 to 4n, and V31 to V3n in this order to reverse-clean the filtration membranes in the modules 4 to 4n. In the cleaning treatment of the reverse osmosis membrane, the cleaning water is caused to flow the treated water tank 5, L5, V4, the pump 9, L7, V10, the module 7, and V8 in this order to clean the reverse osmosis membrane in the module 7.

An effect of the present embodiment will be described.

As shown in FIG. 2, since the plurality of nanofiltration membrane modules 41 to 4n are disposed upstream of the reverse osmosis membrane module 7, a load on the nanofiltration membrane modules 41 to 4n at each of the stages is mitigated, fouling of the nanofiltration membrane module is reduced, and a part of the solute such as an ion and a salt is removed, thereby making it possible to reduce a power cost for the high pressure pump 6 for supplying the raw water to the reverse osmosis membrane module 7, resulting in a reduction of a total running cost.

A summary of a method for calculating a power cost for a pump is as follows.

As the pump power cost, an electric power amount is calculated from a shaft power calculated from the expression (3) and an electric motor output calculated from the following expression (4). Expected efficiency 1 in the expression (3) is detected from a performance curve of the pump.

Ps(kW)=(Q×H)/(3600×η) (3)

Ps is the shaft power; Q is capacity (m³/h); H is a total pump head (kPa); and η is the expected efficiency (%).

Pc=Ps×C (4)

Pc is a pump output; Ps is a shaft power required for calculation; and C is a tolerance (=5%).

The pump power cost was calculated by using the above-described calculation method to investigate the effect of the embodiment, whereby it was revealed that the present embodiment is capable of largely reducing the pump power cost.

### Third Embodiment

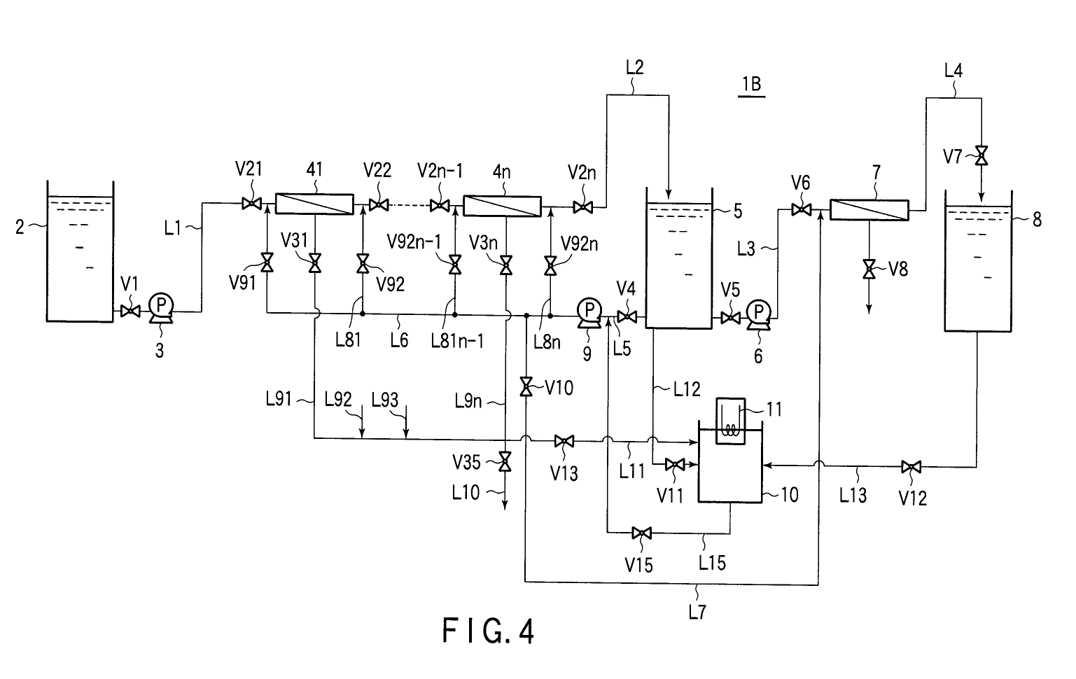

Hereinafter, a membrane filtration system of a third embodiment will be described with reference to FIG. 4. Description for a part of the present embodiment that is in common to the foregoing embodiments will be omitted.

A membrane filtration system 1B of the present embodiment is further provided with a hot water cleaning unit 10, 11, L12, L13, L15, V11, V12, and V15 for cleaning a filtration membrane by using hot water. The hot water cleaning unit comprises a hot water tank 10, a heater 11, piping lines L12, L13, L15, and open/close valve V11, V12, and v15.

The hot water tank 10 comprises the heater 11 for heating water housed inside to 40° C. or higher and a temperature sensor (not shown) and is connected to the hot water supply line L15. A communication is provided between the hot water supply line L15 and cleaning/reverse cleaning lines L6 and L81 to L8n of a nanofiltration membrane and a cleaning line L7 of a reverse osmosis membrane via a plurality of valves V15, V91, V92 to V92n, and V10.

To the hot water tank 10, a primary treated water supply line L12 from a first water tank 5, a secondary treated water supply line L13 from the second treated water tank 8, and a concentrated water line L11 from nanofiltration membrane modules 41 to 4n are connected.

Hereinafter, a function of the present embodiment will be described.

For the filtration, the valves V1, V21 to 2n, V31 to 3n, V8, V5, V6, and V7 are opened, and the valves V31 to V3n, V8, V91 to V9n, V10, V11, V12, and V13 are closed. The raw water is supplied by the first supply pump 3 sequentially to the plurality of nanofiltration membrane modules 41 to 4n, and primary treated water from the nanofiltration membrane module 41 to 4n is supplied to the reverse osmosis membrane module 7 by a high pressure pump 6. A recovery rate K of the nanofiltration membrane module is defined by a flow rate at the valve V22 with respect to a flow rate at the valve V21 as shown in the expression (2). Further, a removal rate R of the nanofiltration membrane module is given by a solute concentration at the membrane module exit with respect to a solute concentration at the membrane module entrance as shown in the expression (1).

There are two types of physical cleanings for the nanofiltration membrane modules 41 and 4n, namely, the cleaning pump 9 is activated in a state where the valves V21 to V2n are closed and the valves 921 to V92n are opened or in a state where the valves V21 to V2n are closed and the valves 921 to V92n are opened followed by opening of the valve V4. Cleaning water is discharged from the modules 41 to 4n via the drain valves V31 to V3n. In the physical cleaning of the reverse osmosis membrane module 7, the cleaning pump 9 is activated in a state where the valves V6 and V7 are closed and the valve V10 is opened. Cleaning water is discharged from the module 7 via the drain valve V8.

In the present embodiment, in addition to the above-described physical cleanings, the filtration membrane and/or the reverse osmosis membrane in the modules is subjected to the hot water cleaning by: introducing the primary treated water from the first treated water tank 5, a part of the concentrated water from the nanofiltration membrane, or the secondary treated water from the second treated water tank 8 into the hot water tank 10 via the line L12, L11, or L13 by opening at least one of the valves V11, V12, and V13; heating by the heater 11; activating the cleaning pump 9 in a state where the valve V15 is opened; and supplying the hot water to the nanofiltration membrane modules 41 to 4n and/or the reverse osmosis membrane module 7 in a state where the valves V91, V92 to V92n, V31 to V3n, V10, and V8 are opened. A temperature of the hot water is adjusted within a range of 40° C. to 100° C.

As to the hot water cleaning, there are two types of cleanings for the nanofiltration membrane modules 41 to 4n like the ordinary physical cleanings, namely, the cleaning pump 9 is activated in a state where the valves V21 to V2n are closed and the valves V91 and V92 to V92n are opened and or in a state where the valves V21 and V2n are closed and the valves V91 and V92 to V92n are opened followed by opening of the valve V15. Cleaning water is discharged via the drain valves V31 to V3n and the valve V35. In the cleaning of the reverse osmosis membrane module 7, the cleaning pump 9 is activated in a state where the valves V6 and V7 are closed and the valve V10 is opened. Cleaning water is discharged from the module 7 via the valve V8.

An effect of the present embodiment will be described.

According to the present embodiment, since the plurality of nanofiltration membrane modules each of which is formed of the nanofiltration membrane for removing a part of the solute are disposed at the stage anterior to the reverse osmosis membrane module, and since the hot water cleaning of passing the water having the temperature higher than the ordinary cleaning water is combined with the ordinary physical cleaning for the nanofiltration membrane module and the reverse osmosis membrane module at a predetermined frequency, fouling of the nanofiltration membrane module is reduced, and a part of the solute such as an ion and a salt is removed, thereby making it possible to reduce a power cost for the high pressure pump for supplying the raw water to the reverse osmosis membrane module, resulting in a reduction of a total running cost.

### Fourth Embodiment

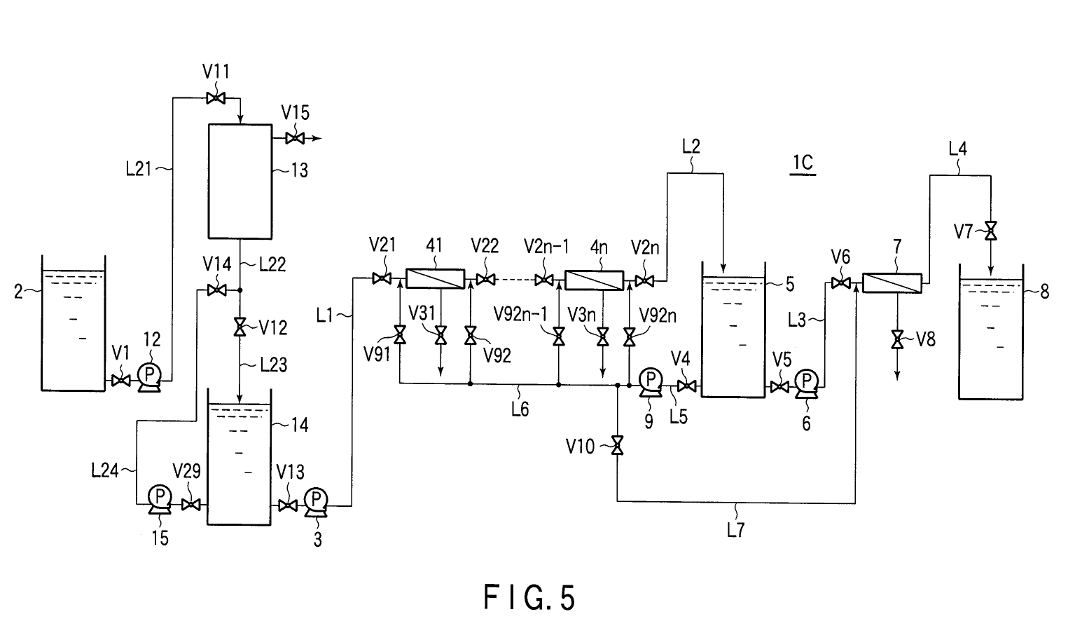

Hereinafter, a membrane filtration system of a fourth embodiment will be described with reference to FIG. 5. Description for a part of the present embodiment that is in common to the foregoing embodiments will be omitted.

The membrane filtration system 10 of the present embodiment comprises a pre-treatment supply pump 12, a sand filtration device 13, a first pre-treated water tank 14, and a second cleaning pump 15 between a raw water tank 2 to a first nanofiltration membrane module 41. The sand filtration device 13 is connected to the raw water tank 2 via the pre-treatment supply pump 12 and a line L21 comprising valves V1 and V11 and comprises a sand charged layer for removing suspended solids and the like contained in raw water in advance of a posterior stage membrane filtration treatment. A communication is provided between an exit of the sand filtration device 13 and the first pre-treated water tank 14 via a line L23, so that pre-treated water is housed in the pre-treated water tank 14 after the sand filtration. A communication is provided between an exit of the pre-treated water tank 14 and the first nanofiltration membrane module 41 via a line L1, so that the pre-treated water is sequentially supplied to the plurality of nanofiltration membrane module 41 to 4n by driving of a first supply pump 3.

Further, a reverse cleaning line L24 is provided between the sand filtration device 13 and the pre-treated water tank 14, so that the pre-treated water from the pre-treated water tank 14 is sent to the sand filtration device 13 in a reverse direction by the driving of the second cleaning pump 15 for reverse cleaning of the sand charged layer. The reverse cleaning line L24 is provided with valves V14 and V29.

Hereinafter, a function and an operation of the present embodiment will be described.

For the filtration, the valves V1, V31 to 3n, V8, V21 to V2n, V5, V6, and V7 are opened, and the valves V31 to V3n, V8, V91 to V9n, and V10 are closed. The raw water is firstly supplied to the sand filtration device 13 by the driving of the pump 12, so that suspended solids and a part of solute is removed by the sand filter layer. The pre-treated water is sent from the sand filtration device 13 to the pre-treated water tank 14 via the line L23 and further sent from the pre-treated water tank 14 to the first stage nanofiltration membrane module 41 via the line L1 by the driving of the pump 3. The pre-treated water sequentially permeates through the filtration membranes of the multi-stage nanofiltration membrane modules 41 to 4n to give primary treated water from which the solute has been removed. The primary treated water is stored in a first treated water tank 5 and supplied to a reverse osmosis membrane module 7 by driving of a high pressure pump 6 to permeate through the reverse osmosis membrane, thereby giving secondary treated water from which a large part of the solute (Na ions and the like) is removed. The secondary treated water is stored in a second treated water tank 8 and sent to devices (not shown) of posterior process steps.

A recovery rate K of the nanofiltration membrane module is defined by a flow rate at the valve V22 with respect to a flow rate at the valve V21 as shown in the expression (2). A removal rate R of the nanofiltration membrane module is defined by a solute concentration at the membrane module exit with respect to a solute concentration at the membrane module entrance as shown in the expression (1).

There are two types of physical cleanings for the nanofiltration membrane modules 41 to 4n, namely, the cleaning pump 9 is activated in a state where the valves V21 to V2n are closed and the valves V91 to V92n are opened or in a state where the valves V21 and V2n are closed and the valves V92 to V92n are opened followed by opening of the valve V4. Cleaning water is discharged from the modules 41 to 4n via the drain valves V31 to V3n. In physical cleaning of the reverse osmosis membrane module 7, the cleaning pump 9 is activated in a state where the valves V6 and V7 are closed and the valve 10 is opened. Cleaning water is discharged from the module 7 via the drain valve V8.

In the present embodiment, in addition to the above-described physical cleanings for the filter membranes, the sand filter layer of the sand filtration device 13 is subjected to physical cleaning. The physical cleaning of the sand filter layer is performed by supplying the pre-treated water in a reverse direction from the pre-treated water tank 14 to the sand filtration device 13 via the reverse cleaning line L24 by the driving of the pump 15. As reverse cleaning operation, the cleaning pump 15 is activated in a state where the valves V12 and V13 are closed and the valves V14, V15, and V29 are opened. Cleaning water is discharged from the sand filtration device 13 via the valve V15.

An effect of the present embodiment will be described.

According to the present embodiment, since the sand filtration device is disposed upstream of the nanofiltration membrane module, fouling of the nanofiltration membrane module is reduced, and a part of the solute such as an ion and a salt is removed, thereby making it possible to reduce a power cost for the high pressure pump for supplying the raw water to the reverse osmosis membrane module, resulting in a reduction of a total running cost.

### Fifth Embodiment

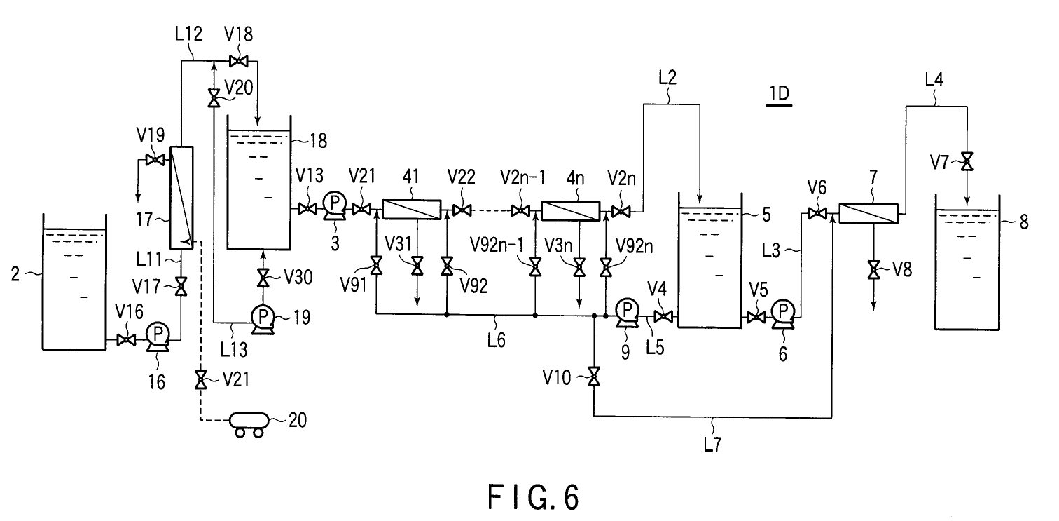

Hereinafter, a membrane filtration system of a fifth embodiment will be described with reference to FIG. 6. Description for a part of the present embodiment that is in common to the foregoing embodiments will be omitted.

A membrane filtration system 1D of the present embodiment comprises a pre-treatment supply pump 16, a MF membrane module 17 as a pre-treatment membrane module, a second pre-treated water tank 18, a third cleaning pump 19, and a compressor 20 between a raw water tank 2 to a first nanofiltration membrane module 41. The MF membrane module 17 is connected to the raw water tank 2 via the pre-treatment supply pump 16 and a line L11 comprising valves V16 and V17 and comprises a microfiltration membrane for removing a solid content (suspended solids, etc.) and a part of solute contained in raw water in advance of a posterior membrane filtration treatment. Though a microfiltration membrane is disposed inside the pre-treatment membrane module 17 in the present embodiment, an ultrafiltration membrane (UF membrane) may be disposed in place of the microfiltration membrane. The microfiltration membrane is a functional filtration membrane that captures particles and polymers having the size larger than 0.01 μm. The microfiltration membrane is abbreviated to as MF membrane (micro filter), and, in general, comprises pores having an average pore diameter that is larger than that of the ultrafiltration membrane. Further, the ultrafiltration membrane is a functional filtration membrane comprising pores that captures particles and polymers having a molecular weight of from several hundreds to several thousands and has an average pore diameter of 2 nm to 200 nm. The ultrafiltration membrane is abbreviated to UF membrane (ultra filter) and, in general, has the average pore diameter that is larger than that of a reverse osmosis membrane and smaller than that of the microfiltration membrane. A communication is provided between an exit of the pre-treatment membrane module 17 and the second pre-treated water tank 18 via a line L12, so that pre-treated water is housed in the pre-treated water tank 18 after the membrane filtration. A communication is provided between an exit of the pre-treated water tank 18 and the first stage nanofiltration membrane module 41 via a line L21, so that the pre-treated water is sequentially supplied to the plurality of nanofiltration membrane modules 41 to 4n by driving of a first supply pump 3.

A reverse cleaning line L13 comprising a valve V20 is provided between the pre-treatment membrane module 17 and the pre-treated water tank 18, so that the pre-treated water from the pre-treated water tank 18 is sent to the module 17 by the driving of the cleaning pump 19 for reverse cleaning of the MF membrane. Further, the compressor 20 is connected to the pre-treatment membrane module 17 via a line comprising an air valve V21. The compressor 20 injects pressurized air into the pre-treatment membrane module 17 in the cleaning to shake the MF membrane, so that deposits are detached from a membrane surface.

An operation of the present embodiment will be described.

For the filtration, the valves V1, V31 to 3n, V8, V21 to V2n, V5, V6, and V7 are opened, and the valves V31 to V3n, V8, V91 to V9n, and V10 are closed. The raw water is supplied to the pre-treatment membrane module 17 by the driving of the pump 16, and a solid content and a part of solute are filtrated when the raw water permeates through the MF membrane, thereby giving pre-treated water that is housed in the pre-treated water tank 18. The pre-treated water is sent from the pre-treated water tank 18 to the first stage nanofiltration membrane module 41 by the driving of the pump 3. The pre-treated water is caused to sequentially permeate through the filtration membranes of the multi-stage nanofiltration membrane modules 41 to 4n to give primary treated water from which the solute is removed. The primary treated water is stored in a first treated water tank 5 and supplied to a reverse osmosis membrane module 7 by driving of a high pressure pump 6 to permeate through the reverse osmosis membrane, thereby giving secondary treated water from which a large part of the solute is removed. The secondary treated water is stored in a second treated water tank 8 and sent to devices (not shown) of posterior process steps.

A recovery rate K of the nanofiltration membrane module is defined by a flow rate at the valve V22 with respect to a flow rate at the valve V21 as shown in the expression (2). A removal rate R of the nanofiltration membrane module is defined by a solute concentration at the membrane module exit with respect to a solute concentration at the membrane module entrance as shown in the expression (1).

There are two types of physical cleanings for the nanofiltration membrane modules 41 to 4n, namely, the cleaning pump 9 is activated in a state where the valves V21 to V2n are closed and the valves 91 and V92 to V92n−1 are opened or in a state where the valves V21 and V2n are closed and the valves V92 to V92n−1 are opened followed by opening of the valve V4. Cleaning water is discharged from the modules 41 to 4n via the valves V31 to V3n. In physical cleaning of the reverse osmosis membrane module 7, the cleaning pump 9 is activated in a state where the valves V6 and V7 are closed and the valve V10 is opened. Cleaning water is discharged from the module 7 via the valve 8.

Physical cleaning of the pre-treatment membrane module 17 is performed in such a manner that the pump 19 is activated in a state where the valves V17 and V18 are closed and the valves V19, V20, and V30 are opened. Simultaneously, the valve V21 is opened, and the compressor 20 is activated so that the pressurized air is supplied to the pre-treatment membrane module 17, thereby shaking the MF membrane. Thus, the solid content deposited on the MF membrane is efficiently detached from the membrane surface, so that a membrane reverse cleaning effect is promoted. Cleaning water is discharged from the module 17 via the valve V19.

An effect of the present embodiment will be described.

According to the present embodiment, since the MF membrane module or the UF membrane module is disposed at the stage anterior to the multistage nanofiltration membrane modules, fouling of the nanofiltration membrane module is reduced, and the load on the reverse osmosis membrane module is mitigated by removing a part of the solute such as an ion and a salt, thereby making it possible to reduce a power cost for the high pressure pump for supplying the water to the reverse osmosis membrane module, resulting in a reduction of a total running cost.

### Sixth Embodiment

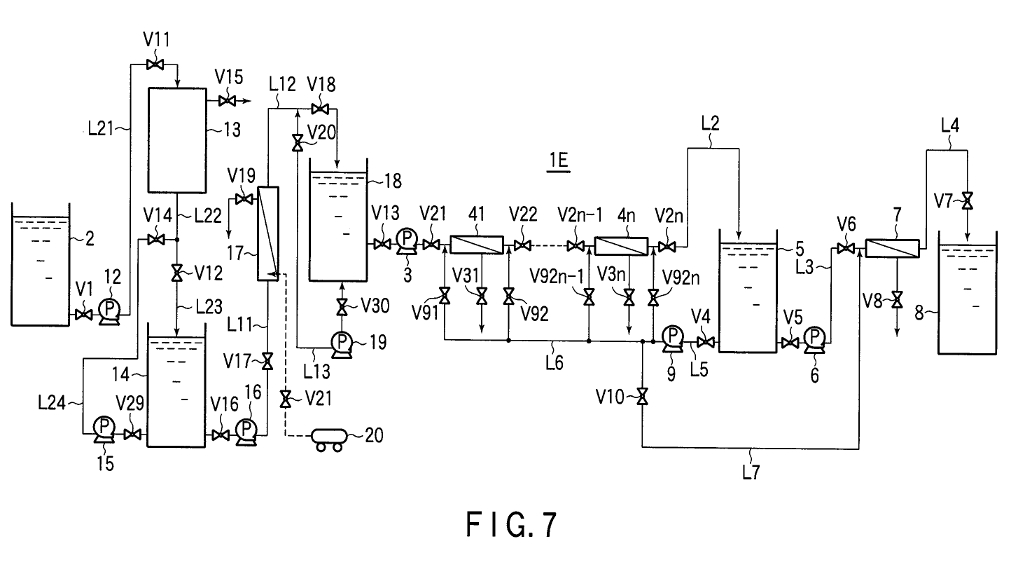

Next, a membrane filtration system of a sixth embodiment will be described with reference to FIG. 7. Description for a part of the present embodiment that is in common to the foregoing embodiments will be omitted.

A membrane filtration system 1E of the present embodiment is a combination of the system 1C of the fourth embodiment and the system 1D of the fifth embodiment and comprises a first pre-treatment supply pump 12, a sand filtration device 13, a first pre-treated water tank 14, a second cleaning pump 15, a second pre-treatment supply pump 16, a MF membrane module 17 as a pre-treatment membrane module, a second pre-treated water tank 18, a third cleaning pump 19, and a compressor 20 between a raw water tank 2 to a first stage nanofiltration membrane module 41.

An operation of the present embodiment will be described.

For the filtration, the valves V1, V31 to 3n, V8, V11, V12, V16, V17, V18, V13, V21 to V2n, V5, V6, and V7 are opened, and the valves V14, V15, V29, V19, V21, V30, V31 to V3n, V8, V91 to V9n, and V10 are closed. The raw water is supplied to the sand filtration device 13 by the driving of the pump 12, and primary pre-treated water obtained by the filtration treatment by the sand filtration device 13 is sent to the pre-treated water tank 14 to be supplied to the MF membrane module 17 by the driving of the pump 16. Secondary pre-treated water obtained by causing the primary pre-treated water to permeate through the MF membrane is sent to the second pre-treatment water tank 18. Subsequently, the secondary pre-treated water is sent from the second pre-treated water tank 18 to the first stage nanofiltration membrane module 41 by the driving of the pump 3. The pre-treated water is caused to sequentially permeate through the filtration membranes of the multi-stage nanofiltration membrane modules 41 to 4n to give primary treated water from which the solute is removed. The primary treated water is stored in a first treated water tank 5 and supplied to a reverse osmosis membrane module 7 by driving of a high pressure pump 6 to permeate through the reverse osmosis membrane, thereby giving secondary treated water from which a large part of the solute is removed. The secondary treated water is stored in a second treated water tank 8 and sent to devices (not shown) of posterior process steps.

A recovery rate K of the nanofiltration membrane module is defined by a flow rate at the valve V22 with respect to a flow rate at the valve V21 as shown in the expression (2). A removal rate R of the nanofiltration membrane module is defined by a solute concentration at the membrane module exit with respect to a solute concentration at the membrane module entrance as shown in the expression (1).

There are two types of physical cleanings for the nanofiltration membrane modules, namely, the cleaning pump 9 is activated in a state where the valves V21 to V2n are closed and the valves V92 to V92n are opened or in a state where the valves V21 and V2n are closed and the valves V92 to V92n are opened followed by opening of the valve V4. Cleaning water is discharged from the modules 41 to 4n via the drain valves V31 to V3n. In physical cleaning of the reverse osmosis membrane module 7, the cleaning pump 9 is activated in a state where the valves V6 and V7 are closed and the valve 10 is opened. Cleaning water is discharged from the module 7 via the drain valve V8.

In the present embodiment, in addition to the above-described physical cleanings for the filtration membranes, the sand filter layer of the sand filtration device 13 is subjected to physical cleaning. The physical cleaning of the sand filter layer is performed by supplying the pre-treated water in a reverse direction from the pre-treated water tank 14 to the sand filtration device 13 via the reverse cleaning line L24 by the driving of the pump 15. As reverse cleaning operation, the cleaning pump 15 is activated in a state where the valves V12 and V13 are closed and the valves V14, V15, and V29 are opened. Cleaning water is discharged from the sand filtration device 13 via the valve V15.

Further, in the present embodiment, the filtration membrane of the pre-treatment membrane module 17 is subjected to physical cleaning. The physical cleaning is performed in such a manner that the pump 19 is activated in a state where the valves V17 and V18 are closed and the valves V19, V20, and V30 are opened. Simultaneously, the valve V21 is opened, and the compressor 20 is activated so that the pressurized air is supplied to the pre-treatment membrane module 17, thereby shaking the MF membrane. Thus, the solid content deposited on the MF membrane is efficiently detached from the membrane surface, so that a membrane reverse cleaning effect is promoted. Cleaning water is discharged from the module 17 via the valve V19.

An effect of the present embodiment will be described.

According to the present embodiment, since the sand filtration device and the MF membrane module or the UF membrane module are disposed at the stages anterior to the multistage nanofiltration membrane modules, fouling of the nanofiltration membrane module is reduced, and a part of the solute such as an ion and a salt is removed, thereby making it possible to reduce a power cost for the high pressure pump for supplying the raw water to the reverse osmosis membrane module, resulting in a reduction of a total running cost.

### Seventh Embodiment

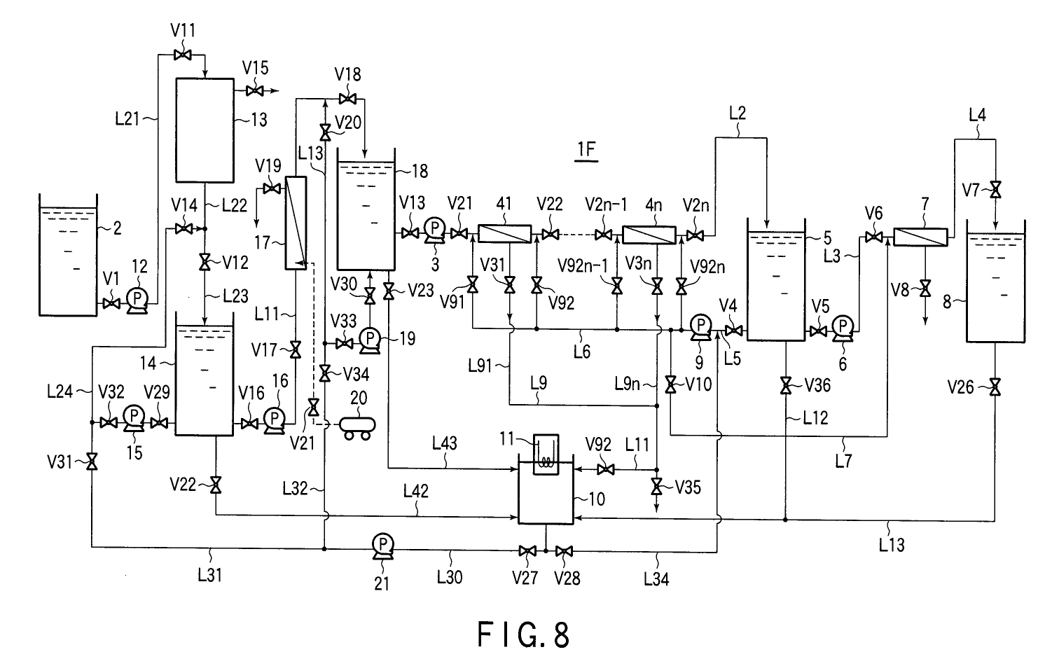

Next, a membrane filtration system of a seventh embodiment will be described with reference to FIG. 8. Description for a part of the present embodiment that is in common to the foregoing embodiments will be omitted.

A membrane filtration system 1F of the present embodiment is a combination of the system 1B of the third embodiment, the system 1C of the fourth embodiment, and the system 1D of the fifth embodiment and comprises a first pre-treatment supply pump 12, a sand filtration device 13, a first pre-treated water tank 14, a second cleaning pump 15, a second pre-treatment supply pump 16, a MF membrane module 17 as a pre-treatment membrane module, a second pre-treated water tank 18, a third cleaning pump 19, and a compressor 20 between a raw water tank 2 to a first stage nanofiltration membrane module 41 as well as a hot water cleaning unit 10, 11, 21, L11, L12, L13, L30, L31, L32, L42, L43, V22, V23, V24, V26, V27, V28, and V36.

The hot water cleaning unit comprises a hot water tank 10, a heater 11, a pump 21, piping lines L12, L13, L30, L31, L32, L42, L43, valves V27 and V28, and the like. The hot water tank 10 comprises the heater 11 for heating water housed inside to 40° C. or higher and a temperature sensor (not shown) and is connected to the first and second hot water supply lines L30 and L34. A communication is provided between the hot water supply line L30 and the reverse cleaning lines L31 and L24 of the sand filter layer via a plurality of valves and between the hot water supply line L30 and the cleaning line L32 of the pre-treatment membrane (MF membrane or UF membrane) via a plurality of valves. A communication is provided between the second hot water supply line L34 and the cleaning/reverse cleaning lines L6 and L81 to L8n of the nanofiltration membrane via a plurality of valves and between the second hot water supply line L34 and the cleaning line L7 of the reverse osmosis membrane via a plurality of valves.

To the hot water tank 10, the line L42 from the primary pre-treated water tank 14, the line L43 from the second pre-treated water tank 18, the primary treated water supply line L12 from the first pre-treated water tank 5, the secondary treated water supply line L13 from the second treated water tank 8, and cleaning water discharge line L11 from the nanofiltration membrane modules 41 to 4n are connected.

An operation of the present embodiment will be described.

For the filtration, the valves V1, V31 to 3n, V8, V11, V12, V16, V17, V18, V13, V21 to V2n, V5, V6, and V7 are opened, and the valves V14, V15, V29, V19, V21, V30, V31 to V3n, V8, V91 to V9n, V10, V22, V23, V24, V26, V36, V27, and V28 are closed. The raw water is supplied to the sand filtration device 13 by the driving of the pump 12, so that primary pre-treated water obtained by the filtration treatment by the sand filtration device 13 is sent to the first pre-treated water tank 14, and the primary pre-treated water is supplied to the MF membrane module 17 by the driving of the pump 16. Secondary pre-treated water obtained by causing the primary pre-treated water to permeate through the MF membrane is sent to the second pre-treated water tank 18. Subsequently, the secondary pre-treated water is sent from the second pre-treated water tank 18 to the first stage nanofiltration membrane module 41 by the driving of the pump 3. The pre-treated water is caused to sequentially permeate through the filtration membranes of the multi-stage nanofiltration membrane modules 41 to 4n to give primary treated water from which the solute is removed. The primary treated water is stored in the first treated water tank 5 and supplied to a reverse osmosis membrane module 7 by driving of a high pressure pump 6 to permeate through the reverse osmosis membrane, thereby giving secondary treated water from which a large part of the solute is removed. The secondary treated water is stored in a second treated water tank 8 and sent to devices (not shown) of posterior process steps.

A recovery rate K of the nanofiltration membrane module is defined by a flow rate at the valve V22 with respect to a flow rate at the valve V21 as shown in the expression (2). A removal rate R of the nanofiltration membrane module is defined by a solute concentration at the membrane module exit with respect to a solute concentration at the membrane module entrance as shown in the expression (1).

There are two types of physical cleanings for the nanofiltration membrane modules, namely, the cleaning pump 9 is activated in a state where the valves V21 to V2n are closed and the valves 921 to V92n are opened or in a state where the valves V21 to V2n are closed and the valves V92 to V92n are opened followed by opening of the valve V4. Cleaning water is discharged from the modules 41 to 4n via the drain valves V31 to V3n. In physical cleaning of the reverse osmosis membrane module 7, the cleaning pump 9 is activated in a state where the valves V6 and V7 are closed and the valve 10 is opened. Cleaning water is discharged from the module 7 via the drain valve V8. Further, in the present embodiment, the pump 9 is activated in a state where the valve V28 is opened, and the hot water is injected from the hot water tank 10 into the cleaning/reverse cleaning line L6 via the line 34. A temperature of the hot water is 40° C. to 100° C.

In the present embodiment, in addition to the above-described physical cleanings for the filtration membranes, the sand filter layer of the sand filtration device 13 is subjected to physical cleaning. The physical cleaning of the sand filter layer is performed by supplying the pre-treated water in a reverse direction from the pre-treated water tank 14 to the sand filtration device 13 via the reverse cleaning line L24 by the driving of the pump 15. As reverse cleaning operation, the cleaning pump 15 is activated in a state where the valves V12 and V13 are closed and the valves V14, V15, and V29 are opened. Cleaning water is discharged from the sand filtration device 13 via the valve V15. Further, in the present embodiment, the pump 21 is activated in a state where the valves V27 and V31 are opened, and the hot water is injected from the hot water tank 10 into the sand filter layer reverse cleaning line L24 via the lines L30 and L31. A temperature of the hot water is 40° C. to 100° C.

Further, in the present embodiment, the filtration membrane of the pre-treatment membrane module 17 is subjected to physical cleaning. The physical cleaning is performed in such a manner that the pump 19 is activated in a state where the valves V17 and V18 are closed and the valves V19, V20, and V30 are opened. Simultaneously, the valve V21 is opened, and the compressor 20 is activated so that the pressurized air is supplied to the pre-treatment membrane module 17, thereby shaking the MF membrane. Thus, the solid content deposited on the MF membrane is efficiently detached from the membrane surface, so that a membrane reverse cleaning effect is promoted. Cleaning water is discharged from the module 17 via the valve V19. Further, in the present embodiment, the pump 21 is activated in a state where the valves V27 and V31 are opened, and the hot water is injected from the hot water tank 10 into the reverse cleaning line L13 of the pre-treatment membrane module 17 via the lines L30 and L32. A temperature of the hot water is 40° C. to 100° C.

An effect of the present embodiment will be described.

According to the present embodiment, as a result of: disposing the plurality of nanofiltration membrane modules formed of the nanofiltration membranes for removing a part of the solute at the stage anterior to the reverse osmosis membrane module; disposing the sand filtration device and the MF membrane module or the UF membrane module at the stages anterior to the multistage nanofiltration membrane modules; and performing the hot water cleaning of passing the water having the temperature higher than the ordinary cleaning water in combination with the ordinary physical cleaning for the nanofiltration membrane module and the reverse osmosis membrane module at a predetermined frequency, fouling of the nanofiltration membrane module is reduced, and a part of the solute such as an ion and a salt is removed, thereby making it possible to reduce a power cost for the high pressure pump for supplying the raw water to the reverse osmosis membrane module, resulting in a reduction of a total running cost.

According to the present embodiment, since the nanofiltration membrane module formed of the nanofiltration membrane for removing a part of the solute is disposed at the stage anterior to the reverse osmosis membrane module used for filtering brackish water, seawater, groundwater, landfill leachate, industrial wastewater, or the like containing solute such as an ion and a salt, fouling of the nanofiltration membrane module is reduced, and a part of the solute such as an ion and a salt is removed, thereby making it possible to reduce a power cost for the high pressure pump for supplying the raw water to the reverse osmosis membrane module, resulting in a reduction of a total running cost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A membrane filtration system comprising:
a raw water tank configured to house raw water containing a solute;
a first treated water tank configured to house primary treated water;
a second treated water tank configured to house secondary treated water;
a nanofiltration membrane module that comprises a nanofiltration membrane, and removes the solute from the raw water with a solute removal rate of 1% or more, and 30% or less;
a first supply pump configured to supply the raw water from the raw water tank to the nanofiltration membrane module to cause the raw water to permeate through the nanofiltration membrane and send the water that has permeated through the nanofiltration membrane as the primary treated water to the first treated water tank;
a reverse osmosis membrane module that comprises a reverse osmosis membrane that further removes the solute from the primary treated water; and
a second supply pump configured to supply the primary treated water from the first treated water tank to the reverse osmosis membrane module to cause the primary treated water to permeate through the reverse osmosis membrane and send the water that has permeated through the reverse osmosis water as the second treated water to the second treated water tank.

2. The membrane filtration system according to claim 1, wherein
the solute removal rate in the nanofiltration membrane module is 1% or more, and 10% or less.

3. The membrane filtration system according to claim 1, comprising a plurality of the nanofiltration membrane modules are disposed upstream of the reverse osmosis membrane module.

4. The membrane filtration system according to claim 1, further comprising
a cleaning unit configured to clean the reverse osmosis membrane and the nanofiltration membrane by supplying hot water having a temperature higher than an ordinary temperature to the reverse osmosis membrane and the nanofiltration membrane.

5. The membrane filtration system according to claim 1, further comprising
a sand filtration device comprising a sand charged layer disposed upstream of the nanofiltration membrane module and downstream of the raw water tank.

6. The membrane filtration system according to claim 1, further comprising
a microfiltration membrane module or an ultrafiltration membrane module disposed upstream of the nanofiltration membrane module and downstream of the raw water tank.

7. The membrane filtration system according to claim 1, further comprising
a sand filtration device and a microfiltration membrane module or a sand filtration device and an ultrafiltration membrane module, disposed upstream of the nanofiltration membrane module and downstream of the raw water tank.

8. The membrane filtration system according to claim 5, further comprising
a cleaning unit configured to clean the reverse osmosis membrane and the nanofiltration membrane, the sand charged layer and the microfiltration membrane, or the sand charged layer and the ultrafiltration membrane, by supplying hot water having a temperature higher than an ordinary temperature to the reverse osmosis membrane and the nanofiltration membrane, the sand charged layer and the microfiltration membrane, or the sand charged layer and the ultrafiltration membrane.
